(19) United States
(12) Patent Application Publication
(10) Pub. No.: US 2016/0212485 A1
(43) Pub. Date: Jul. 21, 2016

(54) ON DEMAND INFORMATION FOR VIDEO

(71) Applicant: TELEFONAKTIEBOLAGET L M ERICSSON (PUBL), Stockholm (SE)

(72) Inventor: Johnny FAHLANDER, Shanghai (CN)

(73) Assignee: TELEFONAKTIEBOLAGET L M ERICSSON (PUBL), Stockholm (SE)

(21) Appl. No.: 14/912,734

(22) PCT Filed: Aug. 23, 2013
(86) PCT No.: PCT/CN2013/082170

§ 371 Date: Feb. 18, 2016

(51) Int. Cl. H04N 21/4725; H04N 21/437

(52) U.S. Cl. CPC H04N 21/4725; H04N 21/437

(57) ABSTRACT

There is provided a method in a client device. The method comprises outputting a video and receiving an information request from a user. The method further comprises initiating a database query, the database query comprising an identity of the video being output and a time index of the playback position at the time the information request was received. The client device may comprise a set top box, a mobile communications device, or any device arranged to receive and output video.

### TECHNICAL FIELD

The present application relates to a method in a client device, a client device, a computer-readable medium, and a user terminal.

### BACKGROUND

When watching video, such as TV program, a sporting event or a film, a viewer will often have questions about the video. Such questions may comprise: “What else has that actor been in?”, “Where did they film this?”, and “Who's playing for that sports team?”. Such questions may relate to the fictional world depicted in the video, for example: “How is that character related to the protagonist?”, and “Where is this scene set?”. These questions often relate to a certain scene, character or other object currently displayed in the video. The static data associated with the program, the short synopsis on the guide which may include a few of the actors' names, is not sufficient to answer these questions. Presently, a viewer must depend on a fellow viewer to hopefully provide the answer, or divert there attention away from the video to perform an internet search in hope of finding the answer.

### SUMMARY

Accordingly, there is provided a method in a client device. The method comprises outputting a video and receiving an information request from a user. The method further comprises initiating a database query, the database query comprising an identity of the video being output and a time index of the playback position at the time the information request was received. The client device may comprise a set top box, a mobile communications device, or any device arranged to receive and output video.

By initiating a database search based upon the identity of the video being watched and a current time index, a user is quickly directed to information relevant to the video and so is more likely to find the answers they are looking for sooner.

The method may further comprise receiving a database response, the database response comprising a list of a plurality of objects in the scene of the video at the time index of the playback position at the time the information request was received. The method may further comprise displaying the list of the plurality of objects via a user interface.

The method may further comprise receiving a user selection of one of the plurality of objects, and in response thereto displaying information about the selected object. The information may comprise a description of the selected object and cross references to other related objects.

The database may comprise a list of information objects in the video and the time indices during the video of when they are displayed on screen. The database may also comprise contextual cross-references between information objects. The database may further comprise screen coordinates of each information object as it appears in the video. The database may be either locally stored or is stored remotely and queried via a communication network. The communication network may include the internet.

The object may comprise: a fictional character, an actor, an individual, a fictional location, or a filming location.

The video may be output on a display, or via a connection to a display.

There is further provided a client device comprising a video output, a user interface and a processor. The video output is arranged to display a video. The user interface is arranged to receive an information request. The processor is arranged to initiate a database query in response to the information request, the database query comprising an identity of the video being output and a time index of the playback position at the time the information request was received. The client device may comprise a set top box, a mobile communications device, or any device arranged to receive and output video.

The client device may further comprise a receiver arranged to receive a database response, the database response comprising a list of a plurality of objects in the scene of the video at the time index of the playback position at the time the information request was received. The method may further comprise displaying the list of the plurality of objects via a user interface. The list may be displayed by the client device or by an auxiliary device.

The client device may further comprise a user interface arranged to receive a user selection of one of the plurality of objects, and in response thereto displaying information about the selected object. The information may comprise a description of the selected object and cross references to other related objects.

The client device may further comprising either a database or a connection to a remote database. The connection may be via a communication network. The communication network may include the internet.

There is further provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

There is further provided a user terminal comprising a processor and memory, said memory containing instructions executable by said processor whereby said user terminal is operative to: output a video; receive an information request from a user; and initiate a database query, the database query comprising an identity of the video being output and a time index of the playback position at the time the information request was received.

There is further still provided a user terminal comprising an antenna, display, transceiver, processor and memory, said memory containing instructions executable by said processor whereby said user terminal is operative to: output a video; receive an information request from a user; and initiate a database query, the database query comprising an identity of the video being output and a time index of the playback position at the time the information request was received.

### BRIEF DESCRIPTION OF THE DRAWINGS

A method and apparatus for on demand information for video will now be described, by way of example only, with reference to the accompanying drawings, in which:

FIG. 1 illustrates a basic method disclosed herein that is implemented in a client device;

FIG. 2 illustrates an alternative method also disclosed herein and implemented in a client device;

FIG. 3 illustrates a TV distribution system incorporating the methods described above;

FIG. 4 is a signaling diagram showing the interaction of the nodes of FIG. 3;

FIG. 5 illustrates a client device arranged to perform the methods described herein;

FIG. 6 illustrates an alternative client device also arranged to perform the methods described herein; and

FIGS. 7 (a) to (g) illustrate an example of the user interface by which the methods described herein may be performed.

### DETAILED DESCRIPTION

In an internet protocol television solution (IPTV) an end user can watch broadcast TV or video on demand (VoD). For the broadcasted programs meta-data is provided through an electronic program guide (EPG). This is delivered either via IPTV middleware, via a direct request to an EPG server, or directly via a DVB stream. For VoD the meta-data is provided with the streamed video by the streaming server using for example OpenStream®. The meta-data provided will include, but is not limited to a video Identity (ID) or a program ID and some static text describing the program or VoD.

Broadcast TV channels may be both locally and network time shifted, allowing for trickplay features such as pause, skip and rewind. The same trickplay features are available for VoD.

There is provided herein a way for a client device that receives video to request information related to a specific time stamp of the video presently on a screen. The information is provided on demand and in response to a query initiated by the user at the client device. Given a program ID and timestamp a list of objects is returned to the client device. The list will then be displayed as a regular list for the end-user. The object list could contain x and y coordinates to allow for markers that will be spread out on the screen to identify the objects contained in the list. The end-user may select one of these information objects, and upon such selection, specific information relating to the object is displayed to the end-user.

An object for which information is provided may comprise, for example: a fictional character, an actor, an individual, a fictional location, or a filming location.

The information relating to the object (information object) will have references to other information objects to show the relations between objects and to allow for retrieving the referenced information object. The information object may contain a list of objects which have more information regarding a certain point of time in the program. In each information object there will be at least one a reference to a time span in the program. Using this program timestamp along with the trickplay feature the user may then skip to other times in the video program where the object appears. Picture-in-Picture (PiP) may be used for displaying such related scenes. In an alternative embodiment where a control device has a suitable display, such related scenes may be displayed on the control device. This may be preferable in live sport events to watch replay of a goal at the same time the viewer can continue watching the game.

Each information object may further comprise references to times in other video programs where the object appears. For example, where the object is a character, the information object may reference the scenes in a series of films that the character has appeared. Where the object is an actor, the information object may reference the scenes in other films of television series that the actor has appeared. Where the information object links to another video such as another episode of a television series or another film; the user may be given the option to begin viewing said series, episode or film from the beginning, as well as watching the referenced scene. The user may also be given the option to add said series, episode or film to a list of items to be watched or to be rented.

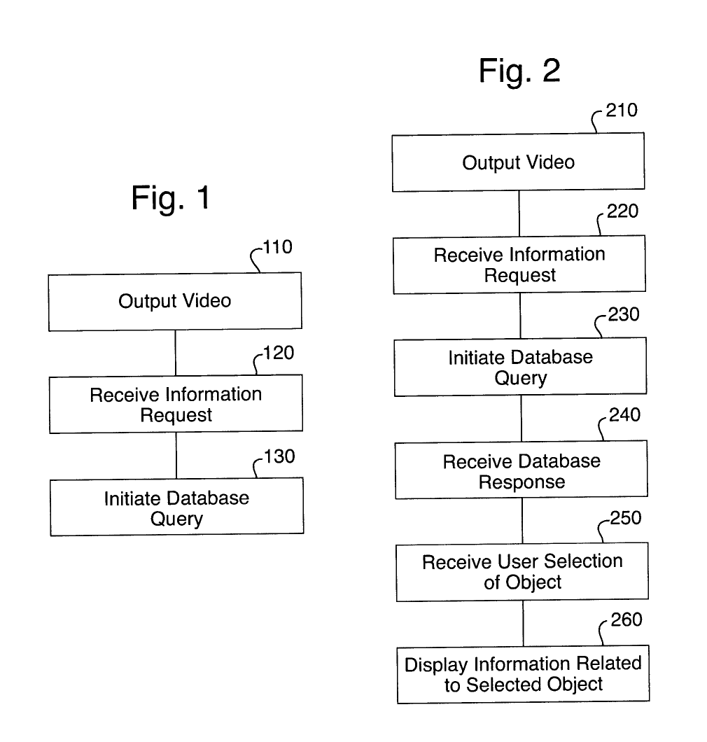

FIG. 1 illustrates a basic method disclosed herein that is implemented in a client device. At 110 a video is output by the client device, either on a display or output via a connection to a display. While the video is playing a user may make an information request 120 via a user interface. The user interface may comprise a button on an infrared remote control, a gesture on a touch sensitive surface, a physical gesture, a voice command, or an interaction with a particular area of a displayed user interface. In response to the information request at 120, the client device initiates a database query 130.

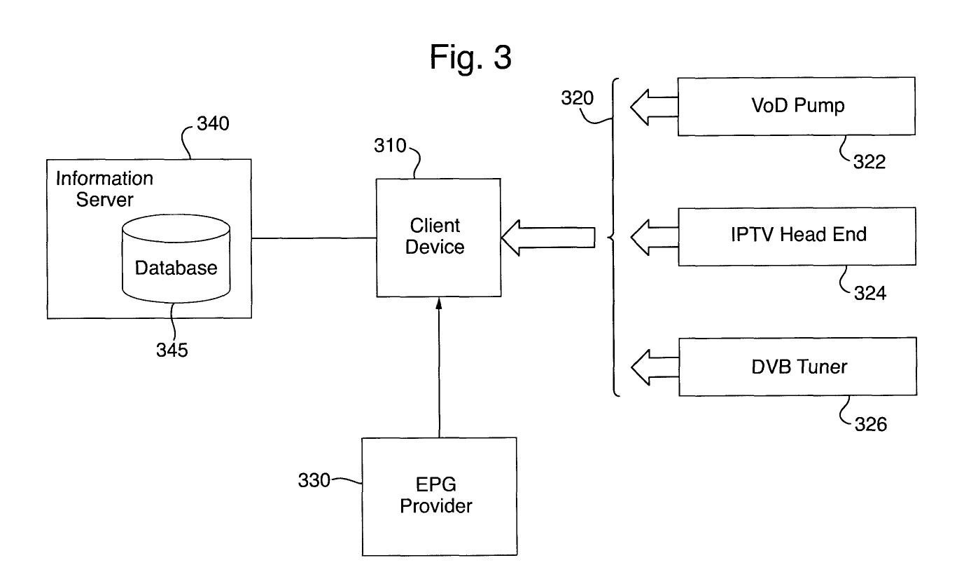

FIG. 2 illustrates an alternative method also disclosed herein and implemented in a client device. Items 210, 220 and 230 correspond to items 110, 120 and 130 as described above. At 240 the client device receives a database response which comprises a list of objects in the scene at the time of the video when the information request was received. At 250 the client device receives a user selection of an object, and at 260 the client device outputs for display information related to the selected object.

The information related to the selected object may be received at 240 in the database response, or may be retrieved from a source (such as the database) in response to the user selection of an object at 250.

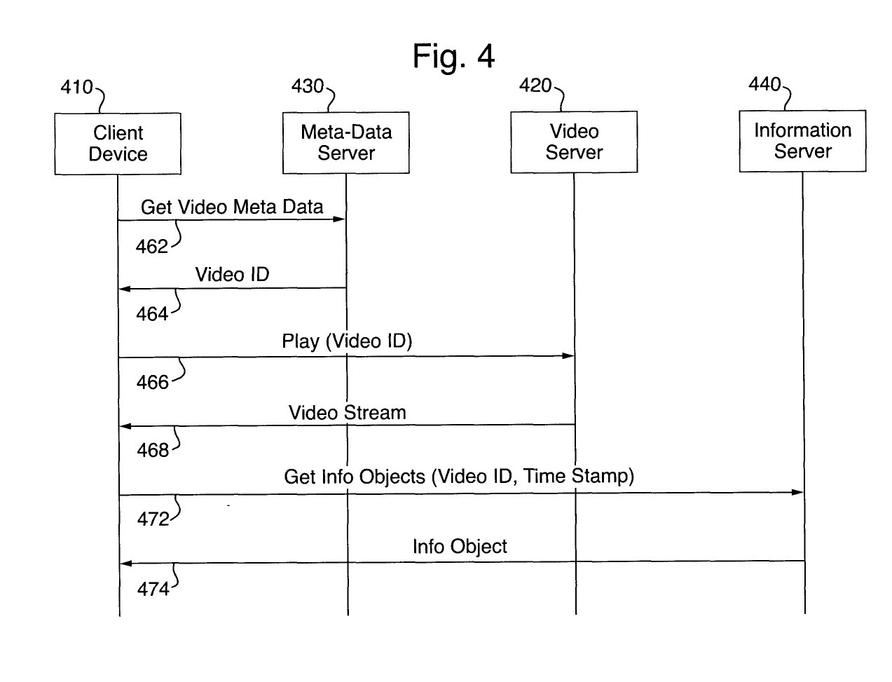

FIG. 3 illustrates a TV distribution system incorporating the methods described above. A client device 310 receives video from a source 320. The video source 320 may comprise a VoD pump 322, an IPTV Head End 324, and/or a DVB Tuner 326. Meta-data about the video is delivered in an electronic program guide (EPG) from an EPG Provider 330. However, where video arrives from a VoD Pump 322 the Meta-data may be delivered as part of a program catalogue from a dedicated server and delivered via the IPTV middleware. Where video arrives from a DVB Tuner 326 the Meta-data may be provided in a DVB transport stream.

An information server 340 comprises a database 345 of information objects. This database comprises a list videos (films/movies, episodes of television series), and lists of objects that appear in them, together time indicators indicating with when those objects are displayed during the video.

Using an information server 340 allows for regular updates of the information object database. The database may be constructed by content providers, network operators, or even other end-users as a wiki. The database may thus become increasingly complex as more links and references are added for the information objects that appear in the videos.

To reduce the number of requests sent to the information server 340, popular information objects, or lists of information objects for popular programs can be sent to the client device and cached in anticipation of a user query. Streaming such information data in the DVB stream, IPTV stream, or VoD stream minimizes request peaks at the information server 340.

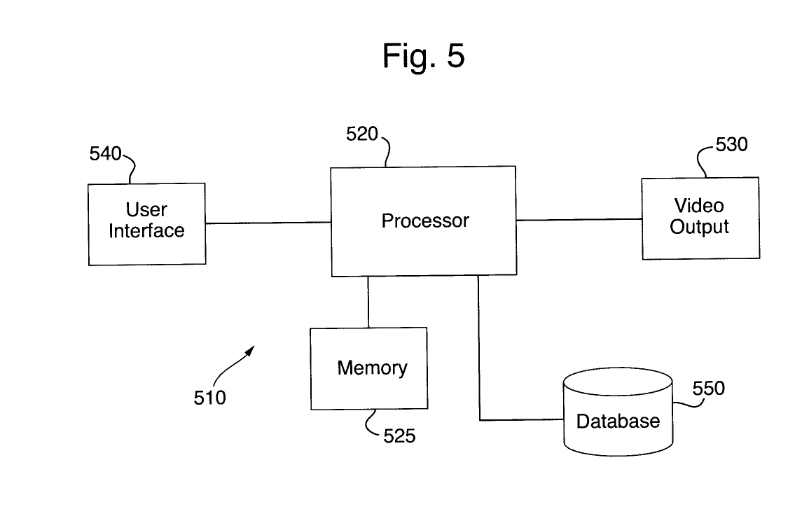

FIG. 4 is a signaling diagram showing the interaction of the nodes of FIG. 3. Once a video is selected for playback, a client device 410 sends a getVideoMetaData message 462 to meta-data server 430. Meta-data server 430 replies with a message 464 comprising a video ID. The client device 410 sends a Play(VideoID) message 466 to video server 420, and in reply video server 420 begins streaming 468 video to the client device 410. At some point during playback of the video the client device receives an information request from the user; this causes the client device 410 to send a getInfoObjects message 472 to the information server 440. The getInfoObjects message 472 includes the VideoID and a timestamp identifying the time during the video playback that the information request was initiated. In reply thereto, information server 440 responds with a list of objects that appear in the video at the particular time, and also the information relating to these objects (the information objects).

The client device 410 has a media player which can include a graphic user interface layer displayed on top of (in front of) the video layer, and from this the user can initiate the sending of a request containing unique identifier and program timestamp to the information server 440.

The unique identifier of the video may be either a program ID retrieved from the meta-data server, which may comprise an EPG entry, or VoD ID retrieved from middleware or a streaming server. The information server 440 will respond with a list of information objects that match this unique id and video timestamp.

The information object itself contains the following attributes.
Video ID (used when server does look up)
Information object ID (used when server does look up from a related object)
List of timestamp duration pairs indicating start and end time stamps of periods when the object is active (used when server does look up or when an end user wants to replay an event)

The following attributes may additionally be provided but are optional.
Object category (real-world, fictional, advertisement)
Object importance or priority, used for sorting lists of objects
Brief summary of the object
Detailed description of the object
List of URI to images of the object
List of references to other information objects
X and Y coordinates along with a radius to pinpoint the object on the screen
View count—how many times this information object has been looked up.

In an alternative embodiment, instead of requests being sent to the server as described above, the information data may be pushed to the client device via a DVB-stream. The information data is then cached at the client device.

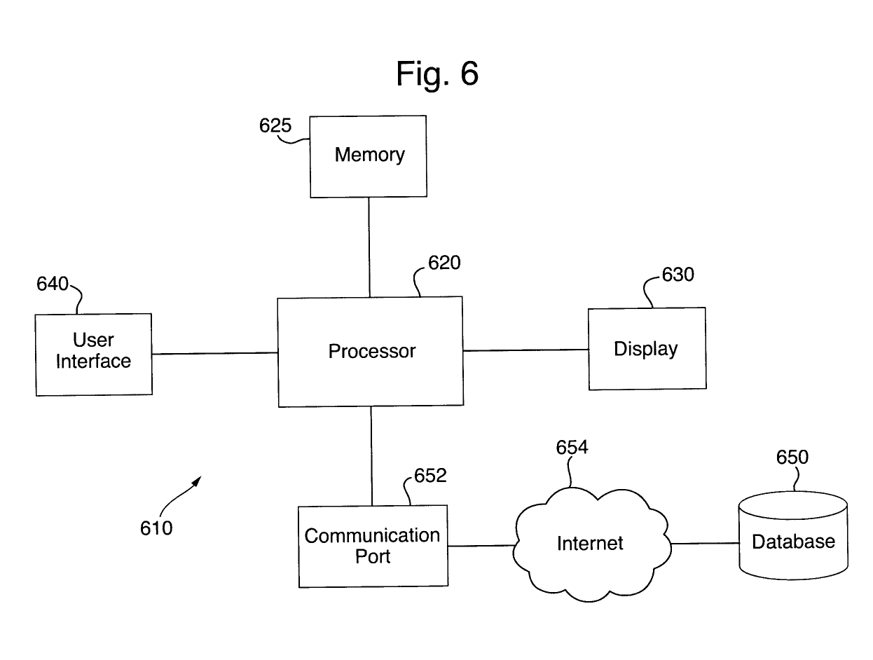

FIG. 5 illustrates a client device 510 arranged to perform the methods described herein. Client device 510 comprises a processor 520, a memory 525, a video output 530, a user interface 540, and a database 550. The processor 520 is arranged to receive instructions which, when executed, causes the processor 520 to carry out the above described method. The instructions may be stored on the memory 525.

The video output 530 is a connection to an external display device. User interface 540 may comprise an infrared push button remote control, or a more advanced user input. Database 550 is stored locally, and for example may be downloaded from an external source or may be stored in conjunction with a video that is also stored in the device 510.

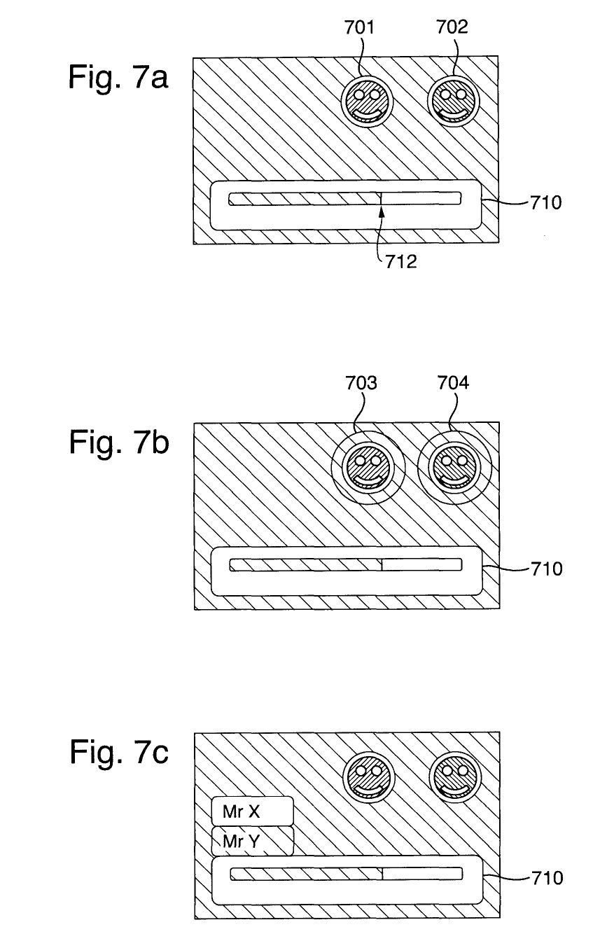

FIG. 6 illustrates an alternative client device 610 also arranged to perform the methods described herein. Client device 610 comprises a processor 620, a memory 625, a display 630, a user interface 640, and a communication port 652. The processor 620 is arranged to receive instructions which, when executed, causes the processor 620 to carry out the above described method. The instructions may be stored on the memory 625.

The display 630 is arranged to show video received by the client device 610. User interface 640 may comprise an infrared push button remote control, or a more advanced user input. Communication port 652 communicates via the internet 654 to a database 650. Database 650 is hosted by a server and may allow for updates of object lists to be recorded.

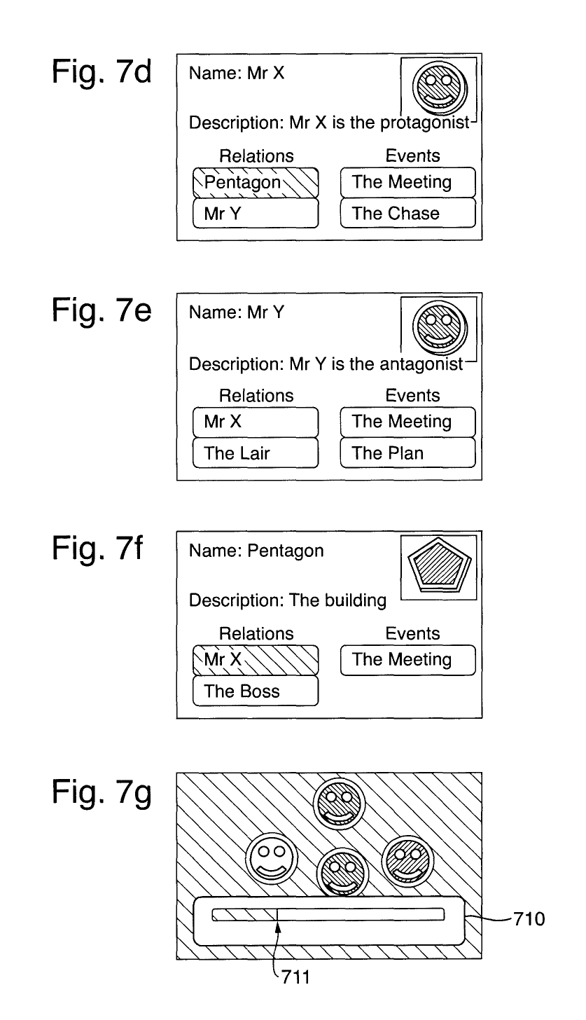

An example of the user interface by which method described herein is performed will now be described with reference to FIGS. 7 (a) to (g). The user is watching a video and at the moment shown two characters 701, 702 are present on screen. FIGS. 7 (a),(b),(c) and (g) show a progress bar 710 illustrating the current playback time of the video. This progress bar 710 is shown only temporarily to the user and would cease to be shown during normal play back of the video, it is always shown here for context.

While watching the scene shown in FIG. 7a the user decides he would like more information about what is currently visible on the screen and so he presses the information key. A request is sent from the client device to the information server with the program ID and a duration timestamp corresponding to time 712 on progress bar 710. The information server performs a look up for this program id and timestamp and returns a list of two information objects, corresponding to the two characters on screen 701 and 702.

FIG. 7b represents what the end user would see if the information object returned included x,y and radius attributes associated with each information object. Here, highlight circles 703,704 are overlaid the video image to illustrate the respective objects 701, 702. FIG. 7c represents what the end user would see without the optional x,y and radius attributes. Here, a list of the names of the objects is displayed; in this case the list comprises “Mr X” and “Mr Y” corresponding to characters 701 and 702 respectively. In either case of FIG. 7b or 7c, the end user can select an object for which he wants more information.

FIGS. 7d and 7e show the information displayed for the selection of Mr X and Mr Y respectively. From this display the user can either select from the list of related information objects as in FIG. 7d or select an event related to the information object as seen in FIG. 7e.

FIG. 7d lists as related to Mr X: “Pentagon” and “Mr Y”. If the user selects “Pentagon” in this view, then FIG. 7f shows the results, an information page related to the Pentagon building.

FIG. 7e lists as related to Mr Y an event “The Plan”. If the user selects “The Plan” in this view, then FIG. 7g shows the results, the client device uses the timestamp attribute of this event and plays the movie/program from this timestamp, 712, in full screen as shown in FIG. 7g. As mentioned above, in alternative embodiments the referenced scene is instead displayed as PiP, or to a control device where such device has suitable display.

An additional feature that may be provided in the information object is a share item option. When viewing an information object a user can select the share item option. This brings up a menu of sharing mechanisms such as email or social media, which can be selected as a means for sharing the information object. The receiver of a shared information object may use the information object ID as entry point to the database, and may use it to locate and watch either a particular scene or the whole program that is referenced.

Certain objects that are included in the database may be advertisements. These may be the result of product placements, related to the content of the video, or simply an advertisement unrelated to the video. Such information objects may include a link to more information about the advertised product or service, or, a purchase link, allowing the user to purchase the advertised product or service.

Herein, “object” is used to define anything contained in or even related to the video being played. “Object” may refer to a real person, item or setting, (e.g. David Prowse, Costume, Elstree Studios) or a fictional person, item or setting (e.g. Darth Vader, Light Sabre, Death Star). Herein, “information object” is used to refer to a database entry or wiki page relating to an object. The “information object” comprises program IDs of the programs the object appears in, and timestamps indicating when in the program the object appears.

From the above it is apparent that by initiating a database search based upon the identity of the video being watched and a current time index, a user is quickly directed to information relevant to the video and so is more likely to find the answers they are looking for sooner.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope

1. A method in a client device, the method comprising:
outputting a video;
receiving an information request from a user; and
initiating a database query, the database query comprising an identity of the video being output and a time index of the playback position at the time the information request was received.

2. The method of claim 1, further comprising receiving a database response, the database response comprising a list of a plurality of objects in the scene of the video at the time index of the playback position at the time the information request was received.

3. The method of claim 2, further comprise receiving a user selection of one of the plurality of objects, and in response thereto displaying information about the selected object.

4. The method of claim 1, wherein the database comprises a list of information objects in the video and the time indices during the video of when they are displayed on screen.

5. The method of claim 1, wherein the database is either locally stored or is stored remotely and queried via a communication network.

6. The method of claim 1, wherein the information object comprises:
a fictional character,
an actor,
an individual,
a fictional location, or
a filming location.

7. The method of claim 1, wherein the video is output on a display, or via a connection to a display.

8. A client device comprising:
a video output arranged to display a video;
a user interface arranged to receive an information request; and
a processor arranged to initiate a database query in response to the information request, the database query comprising an identity of the video being output and a time index of the playback position at the time the information request was received.

9. The client device of claim 8, further comprising receiver arranged to receive a database response, the database response comprising a list of a plurality of objects in the scene of the video at the time index of the playback position at the time the information request was received.

10. The client device of claim 9, further comprising a user interface arranged to receive a user selection of one of the plurality of objects, and in response thereto displaying information about the selected object.

11. The client device of claim 8, further comprising either a database or a connection to a remote database.

12. The client device of claim 8, wherein the information object comprises:
a fictional character,
an actor,
an individual,
a fictional location, or
a filming location.

13. The client device of claim 8, wherein the video output comprises either a display or a connection to a display.

14. A computer-readable medium, carrying instructions, which, when executed by computer logic, causes said computer logic to carry out any of the methods defined by claim 1.

15. A user terminal comprising a processor and memory, said memory containing instructions executable by said processor whereby said user terminal is operative to: output a video; receive an information request from a user; and initiate a database query, the database query comprising an identity of the video being output and a time index of the playback position at the time the information request was received.

16. The user terminal of claim 15, farther comprising an antenna, a display and a transceiver.
